(19) United States
(12) Patent Application Publication
(10) Pub. No.: US 2006/0050912 A1
(43) Pub. Date: Mar. 9, 2006

(54) Shell and tip for hearing aid

(75) Inventors: Robert M. Kidd, Boothbay, ME (US); Eugene D. Fell, Billerica, MA (US)

Correspondence Address: CHRIS A. CASEIRO, VERRILL DANA, LLP, ONE PORTLAND SQUARE, PORTLAND, ME, 04112-0586, US

(73) Assignee: EarCraft, Inc., Topsham, ME (US)

(21) Appl. No.: 10/939,003

(22) Filed: Sep. 9, 2004

(51) Int. Cl. H04R 25/00

(52) U.S. Cl. 381/322; 381/324; 381/328

(57) ABSTRACT

A hearing aid shell and tip for retaining therein hearing aid electronics. The shell body is shaped to conform with the inside shape of the ear to reduce rotation when positioned therein. A head section of the shell positioned deepest in the ear is elliptical in shape to reduce rotation. The tip covers the head section of the shell to separate the shell from direct contact with ear wax. One embodiment of the tip includes grasp tabs to assist in removing the shell and tip from the ear canal and to assist in establishing a snug fit in the ear canal. A second embodiment of the tip has no grasp tabs and is sufficiently pliable to ensure a snug fit around the head section of the shell.

### BACKGROUND OF THE INVENTION

1. Field of the Invention

The present invention relates to hearing aids. More particularly, the present invention relates to the hearing aid shell used to house electronics and a tip used to isolate a portion of the shell from direct contact with the ear.

2. Description of the Prior Art

Hearing aids provide hearing assistance to individuals through sound amplification. The hearing aid operates by detecting sound within the audible frequency range, conversion of that sound into electronic signals that are amplified, and transmitting the amplified signals as sound waves into the ear canal. Miniaturization of the sound detection means and the signal processing electronics has made it possible to produce a complete hearing aid unit that fits within the ear.

As U.S. Pat. No. 5,748,743 issued to Weeks and assigned to the assignee of the present application indicates, there are three general methods for fitting a hearing aid within the ear canal. They include: 1) custom fitting a shell containing the electronics to the individual's ear canal shape; 2) creating one or more standardized shells and selecting the one best suited to the individual; and 3) creating an insert that fits the ear canal opening but not the canal itself. The Weeks patent describes a combined system including a flexible covering designed to block earwax buildup and to assist in fitting within the ear canal.

While a custom fabricated hearing aid shell ensures the user will have the best fit of the aid within the ear canal, it is the most costly and time consuming to obtain. For the purpose of providing a satisfactory hearing aid in a timely manner with an effective fit and at a reasonable price, a standardized shell appears to be the most reasonable approach. Standardized shells may be mass produced in advance, with specific adjustable electronics insertable therein. However, the shapes and sizes of individuals' ear openings and ear canals vary substantially. Therefore, it may be difficult to create a reasonable number of standardized shells configured to fit a substantial number of individuals. In general, the portion of the shell that fits within the ear tends to be of a rectangular shape with rounded corners. Variations tend to be in size and/or length versus width dimensions. Unfortunately, those variants may not be adequate to meet the fit needs of a wide range of individuals. Therefore, what is needed is a standardized hearing aid shell of improved design suitable to retain the necessary electronics and to conform to the shape of the ear opening and canal. Such an improved hearing aid shell would make hearing aids more readily available to a greater segment of the hearing-impaired population. What is also needed is a pliable shell tip to isolate the improved shell from direct contact with the interior of the user's ear at or adjacent to the point where the hearing aid extends furthest into the ear canal. Further, such a protective tip should be designed to minimize insulation of the sound exchange from the hearing aid equipment to the eardrum, and optionally, to enable the user to get the hearing aid out of the ear canal relatively easily.

### SUMMARY OF THE INVENTION

It is an object of the present invention to provide a hearing aid shell of standardized configuration suitable for use by a substantial number of individuals. That object is achieved by the present invention, a hearing aid shell with complex and compound curvature. The curved shape of the shell preferably maps generally inversely to the shape of the ear opening and the beginning of the ear canal of a majority of individuals.

It is also an object of the present invention to provide a pliable shell tip to isolate a hearing aid shell, such as the improved shell described herein, from direct contact with the interior of the user's ear at or adjacent to the point where the hearing aid extends furthest into the ear canal. It is a further object of the present invention to provide such a protective tip should be designed to minimize insulation of the sound exchange from the hearing aid equipment to the eardrum, and optionally, to enable the user to get the hearing aid out of the ear canal relatively easily. These objects are achieved through the application of a removable pliable shell tip to be described herein that fits over the operational end of the shell and spaces that end of the shell from direct contact with the user's ear canal.

The hearing aid shell of the present invention includes an ear canal entry section and an electronics retaining section, preferably forming a unitary shell. The ear canal entry section is of a first elliptical shape and then curves through a transition stage to the electronics retaining section that is of a second elliptical shape. A first side of the shell has a substantially continuous curvature whereas a second side, the one that is closer to the user's head when the hearing aid is in place, has three curvatures. The first curvature of the second side forms part of the ear canal entry section, the second curvature forms part of the transition stage, and the third curvature forms part of the electronics retaining section. Prior hearing aid shells, such as the one shown in the Weeks patent incorporated herein by reference, transition abruptly from the ear opening contact portion to the electronics retaining portion. The shell of the present invention transitions smoothly through the three different curvatures, in substantial conformance with most ear shapes. Further, the end of the shell that is designed to be positioned closest to the user's eardrum is also preferably of an elliptical shape to assist in a snug fit within the ear canal and to minimize rotation of the device.

The hearing aid shell tip of the present invention is a pliable structure intended for removable application over the shell. The tip includes a tip head within which the head of the shell is removably retained. The tip head is preferably relatively thin where the contact is closest to the eardrum such that minimal sound insulation occurs. The thin section may include one or more perforations through which sound may pass while blocking ear wax from direct attachment to the shell head end. The tip may be fabricated in a relatively small number of standardized sizes, thereby reducing manufacturing costs. The shell tip isolates a portion of the shell from direct contact with the ear, aids in reducing wax buildup on the shell, and assists in establishing a snug fit within the ear canal by taking up shape variations.

The hearing aid shell of the present invention may be fabricated of any material but is preferably fabricated of a non-metallic material suitable to retain the electronics therein and to stand up to the environmental conditions to be expected. The shell may be fabricated in substantially uniform configurations, with variants in specific dimensions to accommodate common variations among a broad range of individuals. The result is a standardized hearing aid shell design that may be produced in an effective manner and readily available for individuals at less expense than associated with customized hearing aids. The hearing aid shell tip of the present invention may be fabricated of any material but is preferably fabricated of a non-metallic material that is comfortable in the ear, durable, and fits snugly to the shell when placed thereon. The shell tip may be fabricated in substantially uniform configurations, with variants in specific dimensions to accommodate common variations among a broad range of individuals. The result is a standardized optional hearing aid shell tip that may be produced in an effective manner and readily available for individuals at less expense than associated with customized hearing aids. These and other advantages of the novel hearing aid shell and shell tip will become further apparent upon review of the following detailed description and the accompanying drawings.

### BRIEF DESCRIPTION OF THE DRAWINGS

FIG. 1 is a perspective view of a right-ear version of the hearing aid shell of the present invention, showing a front end thereof. It is to be understood that a left-ear version is a mirror image of the right-ear version.

FIG. 2 illustrates a distal side of the right-ear version of the hearing aid shell shown in phantom.

FIG. 3 illustrates a front end of the right-ear version of the hearing aid shell.

FIG. 4 illustrates a proximal side of the right-ear version of the hearing aid shell.

FIG. 5 illustrates an anterior side of the right-ear version of the hearing aid shell.

FIG. 6 illustrates a back end of the right-ear version of the hearing aid shell.

FIG. 7 is a partial cut-away of the hearing aid shell of the present invention looking to the back end thereof.

FIG. 8 is a cross-sectional view of the hearing aid shell taken at section A-A of FIG. 7.

FIG. 9 is a plan view of a first embodiment of the hearing aid shell tip of the present invention.

FIG. 10 is a cross-sectional elevation view of the first embodiment of the hearing aid shell tip of the present invention.

FIG. 11 is a cross-sectional close-up elevation view of the head of the first embodiment of the hearing aid shell tip.

FIG. 12 is a plan view of the head of the first embodiment of the hearing aid shell tip showing the optional tip end perforations.

FIG. 13 is an elevation view of a second embodiment of the hearing aid shell tip of the present invention.

FIG. 14 is a plan view of the second embodiment of the hearing aid shell tip of the present invention.

### DETAILED DESCRIPTION OF THE PREFERRED EMBODIMENT

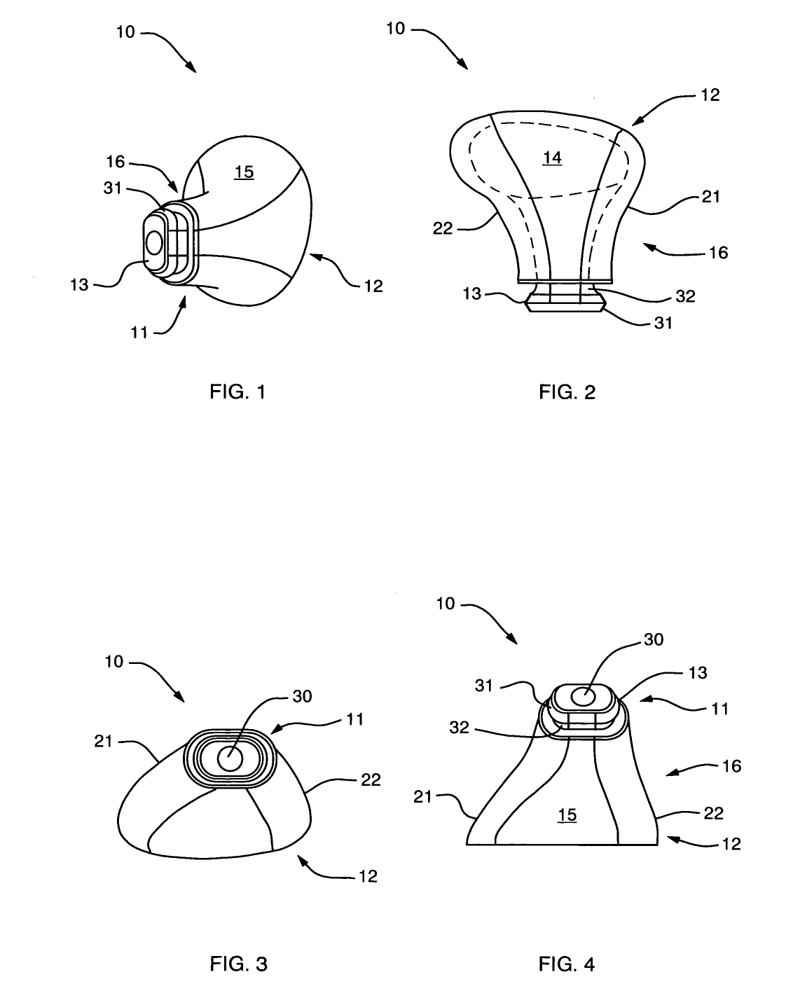

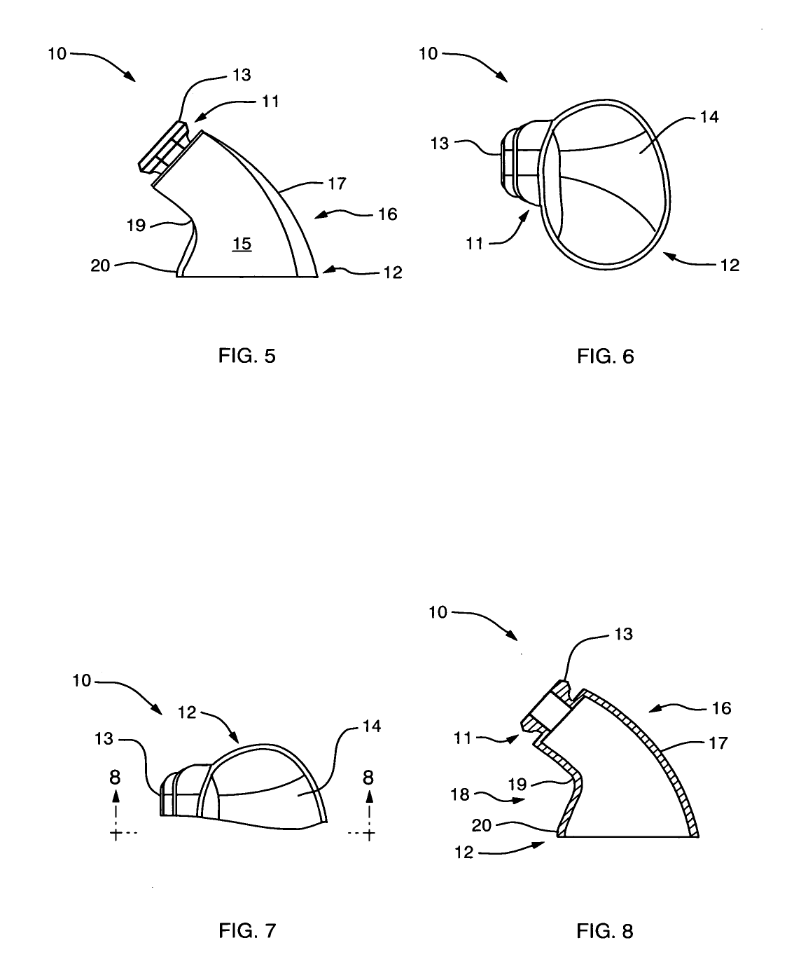

A hearing aid shell 10 of the present invention is shown in FIGS. 1-8. The hearing aid shell 10 shown in FIGS. 1-8 is a right-ear version thereof. It is to be understood that a left-ear version would be a mirror image of the right-ear version. Therefore, the following detailed description of the shell 10 is applicable to both right-ear and left-ear versions. The shell 10 includes a front end 11 and a back end 12. The front end 11 is designed for insertion into the ear canal. It includes a head section 13 for receiving and retaining thereon an optional removable hearing aid shell tip to be described herein. The shell tip is designed to separate the head section 13 from direct physical contact with the interior of the ear so as to reduce wax buildup on the front end 11, and to aid in establishing a snug fit in the ear. The back end 12 includes a port 14 for insertion into a shell body 15 the electronics required to effect the amplification of sound entering a hearing aid including the shell 10. A removable faceplate (not shown) may be placed over the port 14 after insertion of the electronics to retain the electronics in place and to position one or more control knobs thereon for adjustment of the hearing aid.

The head section 13 of the front end 11 is preferably fabricated in a shape that reduces the possibility of rotation of the hearing aid within the ear. As shown in FIGS. 1 and 3-4, the head section 13 may be elliptical in shape, with a sound port 30 substantially centered therein to maximize sound transmission to the eardrum. The head section 13 includes a tip retaining flange 31 on which the optional shell tip may be removably retained. The retaining flange 31 transitions to a neck 32 joining the head section 13 to the remainder of the front end 11 described herein. It is to be understood that the head section 13 may be formed in other shapes, such as oval, round, or rectangular, for example.

The front end 11 of the shell 10 after the head section 13 is preferably arranged in an elliptical shape, with the larger dimension thereof running vertically when the shell 10 is positioned within the ear. The back end 12 of the shell 10 at the area including the port 14 is also of an elliptical shape, with the larger dimension running vertically when the shell 10 is positioned within the ear. The back end 12 is larger than the front end 11. The shell body 15 includes a transition region 16 to establish the expansion of the dimensions of the front end 11 to the back end 12 while accounting for the change of the features of the ear into which the shell 10 is inserted.

The transition region 16 includes at a distal side 17 of the shell 10 (the side away from the user's head when the shell 10 is positioned within the ear) a simple convex curve portion. The transition region 16 also includes at a proximal side 18 of the shell 10 (the side adjacent to the user's head when the shell is positioned within the ear) a compound curve portion, with a front concave portion 19 and a back convex portion 20. The arrangement of the concave portion 19 and the convex portion 20 in combination is designed to conform with the curvature of the inside of the ear and the shape of the outer portion of the ear against which the shell 10 rests. Further, the transition region 16 includes first expansion region 21 and second expansion region 22 for expansion of the larger dimension of the ellipse of front end 11 into the larger dimension of the ellipse of back end 12.

The shell 10 shown in the accompanying drawings may be fabricated of any material suitable for retaining electronics therein and preferably not irritating to the user. For example, the shell 10 may be fabricated of a non-metallic material, such as a viscoelastic material including a plastic or relatively rigid rubber. The shell 10 may be fabricated as a unitary structure or of two or more modular sections. The dimensions of the front end 11, the back end 12, and the transition region 16 may be varied but are preferably limited to a relatively few variants in order to minimize manufacturing costs. The specific radii of curvature of the distal side 17, the proximal side 18, and the first and second expansion regions 21 and 22 may be selected by the manufacturer but preferably conform generally to the shape and dimensions of the inside and outside of the ear.

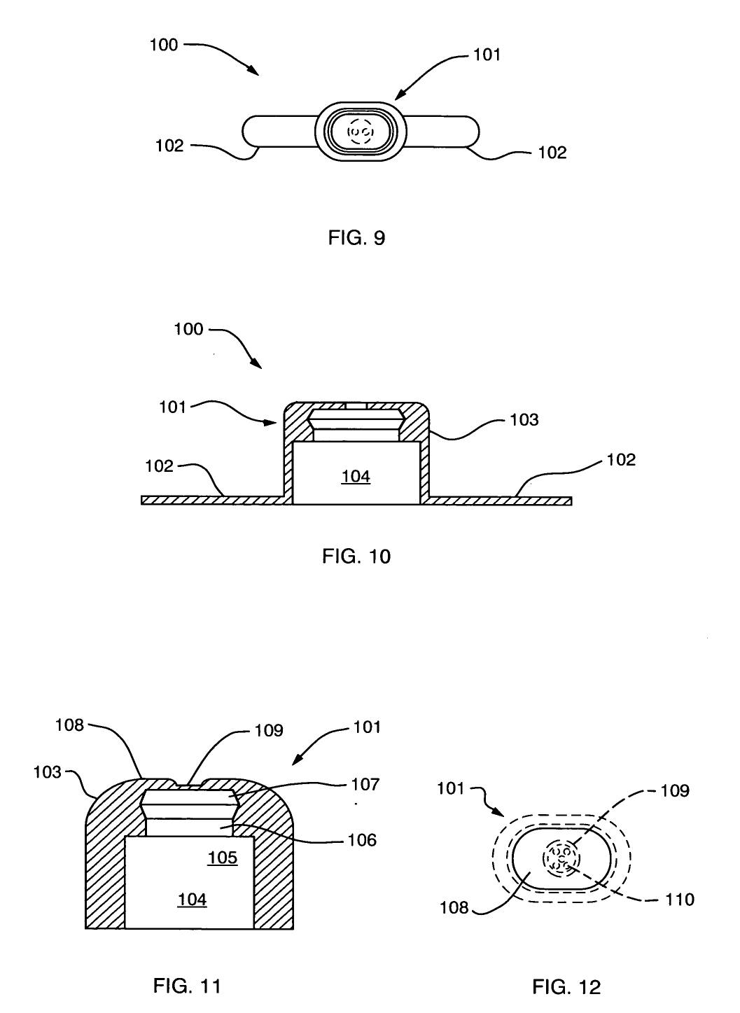

A first hearing aid shell tip 100 of the present invention is shown in FIGS. 9-11. The hearing aid shell tip 100 is intended for use as an intermediate piece between a shell containing hearing aid equipment, such as shell 10, and the user's ear. The hearing aid shell tip 100 is designed to fit over, and be removably positioned on, a hearing aid shell such as shell 10 of FIGS. 1-8. The tip 100 includes a tip head 101 and one or more grasp tabs 102. The tip head 101 includes a pliable housing 103 shaped to establish a shell chamber 104 therein. The shell chamber 104 is preferably fabricated in a shape that substantially conforms with the shape of a shell head, such as head section 13 of the shell 10 of FIGS. 1-8, and preferably having dimensions greater than the outside dimensions of the shell head. The cross sectional representation of the tip 100 shown in FIG. 10 illustrates such conformal design. However, it is to be understood by those skilled in the art that the housing 103 may be fabricated with dimensions that are smaller than those of the shell head, and that may not be apparently conformal in appearance, provided the pliable housing 103 is sufficient pliable to fit snugly about the shell head to be covered.

With reference to FIGS. 9 and 10, the grasp tabs 102 of the tip 100 are either attached to, or form an integral part of, the tip head 101. The grasp tabs 102 extend a selectable length out from the locations where they join the tip head 101. They should be of sufficient length, however, such that when a hearing aid including the shell tip 100 is inserted into the ear, the one or more grasp tabs 102 extend along the exterior surface of the hearing aid shell away from the ear canal to a position or positions that they may be grasped by the user and used to remove the hearing aid from the ear canal. That length is dependent upon the length of the hearing aid shell on which the tip 100 is placed.

Preferably, the tip head 101 and the one or more grasp tabs 102 of the tip 100 are fabricated in a single fabrication process, including formation of the shell chamber 104, such as in a single molding process. However, other means of forming and joining the tip head 101 and the grasp tabs 102 may be employed. For example, a solid piece of material may be formed with outside dimensions of the tip head 101 and the shell chamber 104 cut or otherwise machined out of the solid piece. The grasp tabs 102 could then be mechanically or chemically affixed to the tip head 101 where the tip head 101 and the tabs 102 join. The tip 100 is preferably fabricated of a non-metallic material, such as a viscoelastic material including, but not limited to, silicone or latex rubber. As shown in FIG. 11, the shell chamber 104 of the tip head 101 may be of relatively complex configuration, including a main chamber section 105, and a head end chamber section 106. The head end section 106 is preferably configured to conform substantially with the elliptical design of the head section 13 of shell 10, and includes a shell head retaining neck 107 for releasably retaining the head section 13 therein under normal use conditions.

With reference to FIGS. 11 and 12, the pliable housing 103 includes a housing end 108 that is intended to be positioned deepest into the ear canal when the hearing aid is deployed. The housing end 108 includes a reduced material section 109 substantially centered with respect to the cross section of the housing end 108. The reduced material section 109 is designed to ensure that as little material having any sound insulation characteristics as possible is positioned between the hearing aid equipment contained within the shell and the ear drum of the user. However, the housing end 108 preferably includes some material in that location so that ear wax does not accumulate directly on the hearing aid shell. The reduced material section 109 of the housing end 108 may optionally include one or more tip perforations 110 sized and spaced to minimize ear wax filling while allowing some sound to travel directly from the hearing aid to the ear drum without passing through the potentially insulative tip material.

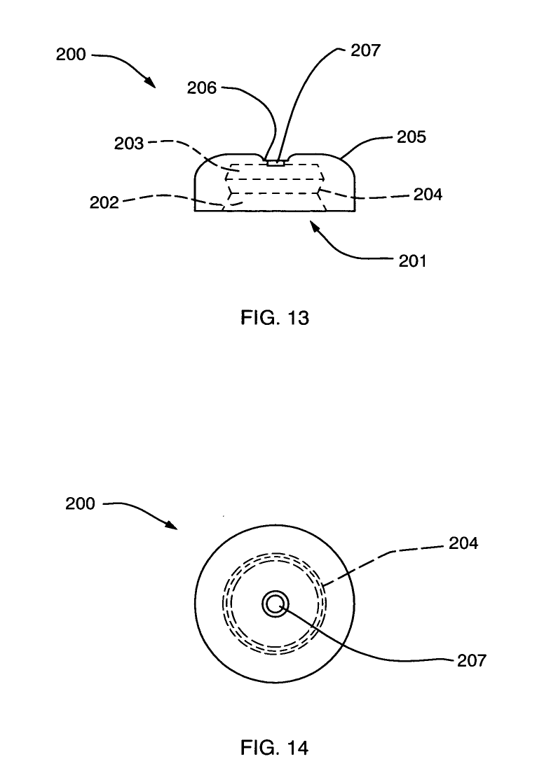

A second hearing aid shell tip 200 of the present invention is shown in FIGS. 13 and 14. The hearing aid shell tip 200 is intended for use as an intermediate piece between a shell containing hearing aid equipment, such as shell 10, and the user's ear. The hearing aid shell tip 200 is designed to fit over, and be removably positioned on, a hearing aid shell such as shell 10 of FIGS. 1-8. The tip 200 is a pliable end cap housing shaped to establish a shell chamber 201 therein. The shell chamber 201 is preferably fabricated in a shape that substantially conforms with the shape of a shell head, such as head section 13 of the shell 10 of FIGS. 1-8. The tip 200 is preferably fabricated with dimensions smaller than the dimensions of the head section 13 of the shell 10 such that it must be stretched to fit over the head section 13 and fit snugly thereon. As a result, as shown in FIG. 14, the tip 200 may not be apparently conformal to the shape of the head section 13. The tip 200 is preferably fabricated of a non-metallic material, such as a viscoelastic material including, but not limited to, silicone or latex rubber.

The shell chamber 201 of the tip 200 preferably includes a trapezoidal main chamber section 202, and a head end chamber section 203. The head end chamber section 203 includes a shell head retaining neck 204 for releasably retaining the head section 13 therein under normal use conditions. The tip 200 includes a tip end 205 that is intended to be positioned deepest into the ear canal when the hearing aid is deployed. The tip end 205 includes a reduced material section 206 substantially centered with respect to the cross section of the tip end 205. The reduced material section 206 is designed to ensure that as little material having any sound insulation characteristics as possible is positioned between the hearing aid equipment contained within the shell and the ear drum of the user. However, the tip end 205 preferably includes some material in that location so that ear wax does not accumulate directly on the hearing aid shell. The reduced material section 206 of the tip end 205 may optionally include one or more tip perforations 207 sized and spaced to minimize ear wax filling while allowing some sound to travel directly from the hearing aid to the ear drum without passing through the potentially insulative tip material.

It is to be understood that either tip 100 or tip 200 may be employed with other hearing aid shell types and is not limited to usage solely with shell 10. It is also to be noted that the shell 10 may be used with other covering tips than tips 100 and 200, or without any covering tip at all. The materials used to fabricate the shell 10, the first tip 100 and the second tip 200 may be selected as a function of the particular fabrication and environmental conditions expected.

While the present invention has been described with particular reference to certain embodiments of the shell, tips, and combinations of shell and tips, it is to be understood that it includes all reasonable equivalents thereof as defined by the following appended claims.

What is claimed is:

1. A shell for retaining hearing aid electronics therein, the shell comprising:
a. a body for retaining electronics therein; and
b. a head section extending from the body, the head section configured to reduce rotation of the shell when deployed in a person's ear.

2. The shell as claimed in claim 1 wherein the head section is elliptically shaped.

3. The shell as claimed in claim 1 wherein the head section includes a sound port substantially centered therein.

4. The shell as claimed in claim 1 wherein the head section includes a tip retaining flange.

5. The shell as claimed in claim 4 further comprising a neck between the head section and the body.

6. The shell as claimed in claim 1 wherein the shell includes a first end corresponding to the head section and a second end corresponding to a back end of the body, wherein the body includes a transition region such that dimensions of the first end are smaller than dimensions of the second end.

7. The shell as claimed in claim 6 wherein the transition region includes a concave portion and a convex portion, wherein the concave portion and the convex portion in combination establish a shape of the body to conform with the shape of the curvature of the inside of a person's ear.

8. A hearing aid shell tip comprising a housing defining a chamber therein, wherein the chamber is configured and arranged to releasably retain therein a hearing aid shell, and wherein the housing includes a housing end including a reduced material section.

9. The tip as claimed in claim 8 further comprising a shell head retaining neck.

10. The tip as claimed in claim 8 wherein the chamber is of elliptical shape.

11. The tip as claimed in claim 8 wherein the chamber is of round shape.

12. The tip as claimed in claim 8 further comprising one or more grasp tabs extending from the housing.

13. The tip as claimed in claim 12 wherein the one or more grasp tabs are integrally formed with the housing.

14. The tip as claimed in claim 8 further comprising one or more perforations in the reduced material section.

15. An apparatus for retaining hearing aid electronics therein, the apparatus comprising:
a. a shell including a body for retaining electronics therein, and a head section extending from the body, the head section configured to reduce rotation of the shell when deployed in a person's ear; and
b. a shell tip comprising a housing defining a chamber therein, wherein the chamber is configured and arranged to releasably retain therein the head section of the shell.

16. The apparatus as claimed in claim 15 wherein the shell tip includes a tip end having a reduced material section.

17. The apparatus as claimed in claim 16 wherein the reduced material section includes one or more perforations.

18. The apparatus as claimed in claim 15 wherein the head section of the shell includes a flange for releasably retaining the tip thereon.

19. The apparatus as claimed in claim 18 wherein the head section of the shell is of elliptical shape.

20. The apparatus as claimed in claim 19 wherein the tip chamber is either of elliptical or round shape.
